(19) United States
(12) Patent Application Publication
(10) Pub. No.: US 2007/0271087 A1
(43) Pub. Date: Nov. 22, 2007

(54) Language-independent language model using character classes

(75) Inventors: Petr Slavik, Kirkland, WA (US); Patrick M. Haluptzok, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/436,354

(22) Filed: May 18, 2006

(51) Int. Cl. G06F 17/27

(52) U.S. Cl. 704/9

(57) ABSTRACT

Various technologies and techniques are disclosed that improve handwriting recognition accuracy. A set of character classes that are suitable across the various languages to be supported is established. The characters in one or more of the languages to be supported are grouped into the character classes. Probabilities are determined for the character classes. The character classes and the character class probabilities are used in a language-independent language model. The language-independent language model is then used to improve handwriting recognition operations when ambiguous handwriting is input by a user. The recognized characters are displayed to the user after the ambiguity is resolved.

### BACKGROUND

To improve quality of results, handwriting recognizers typically use some kind of language model to restrict the number of choices a recognizer has. Typically, a language model consists of a (large) lexicon of allowed words plus additional rules for creating phone numbers, addresses, etc. These lexicons and rules usually depend on the language that the recognizer is trying to recognize. Creating such lexicons and rules for any given language is complicated and expensive.

### SUMMARY

Various technologies and techniques are disclosed that improve handwriting recognition accuracy. A set of character classes that are suitable across the various languages to be supported is established. The characters in one or more of the languages to be supported are grouped into the character classes. Probabilities are determined for the character classes. The character classes and the character class probabilities are used in a language-independent language model. The language-independent language model is then used to improve handwriting recognition operations when ambiguous handwriting is input by a user. In one implementation, the handwriting of the user can be input in one of the languages used to generate the character class probabilities, or in any of the other supported languages. The recognized characters are displayed to the user after the ambiguity is resolved.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a handwriting recognition application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in resolving ambiguous handwritten input using character classes.

FIG. 5 is a process flow diagram for one implementation of the system of FIG. 1 illustrating the stages involved in using character class probabilities to improve recognition.

FIG. 6 is a process flow diagram for one implementation of the system of FIG. 1 illustrating the stages involved in using character classes from a first language to improve handwriting accuracy for a second language.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that improves handwriting recognition, but the system also serves other purposes in addition to these. In one implementation, one or more of the techniques described herein can be implemented as features within a handwriting recognition application, or from any other type of program or service that includes a handwriting recognition feature.

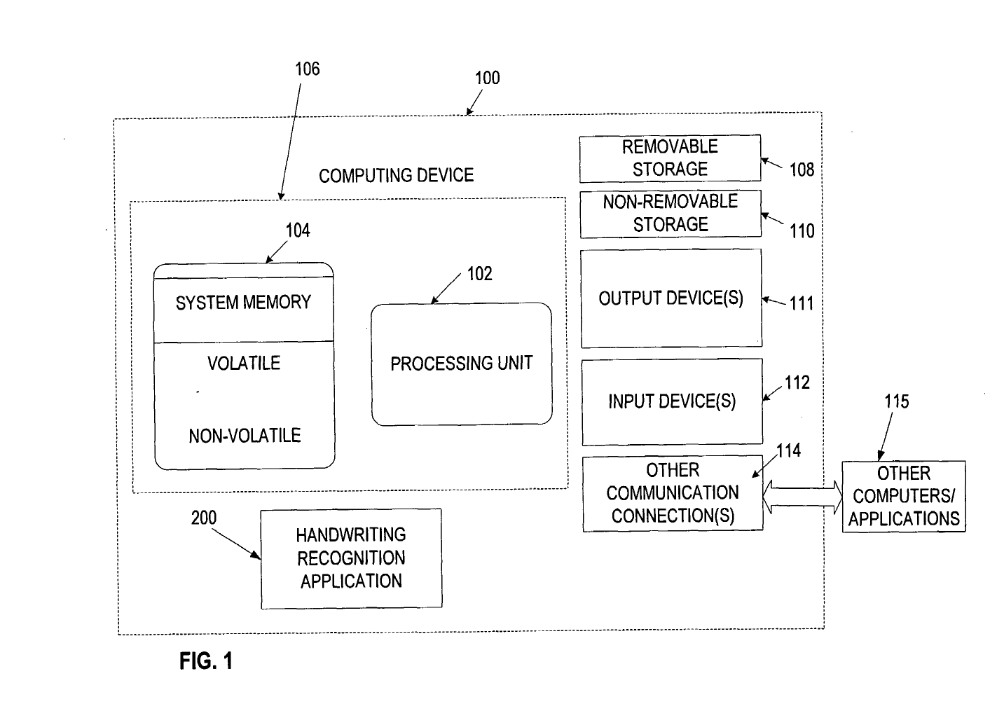

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

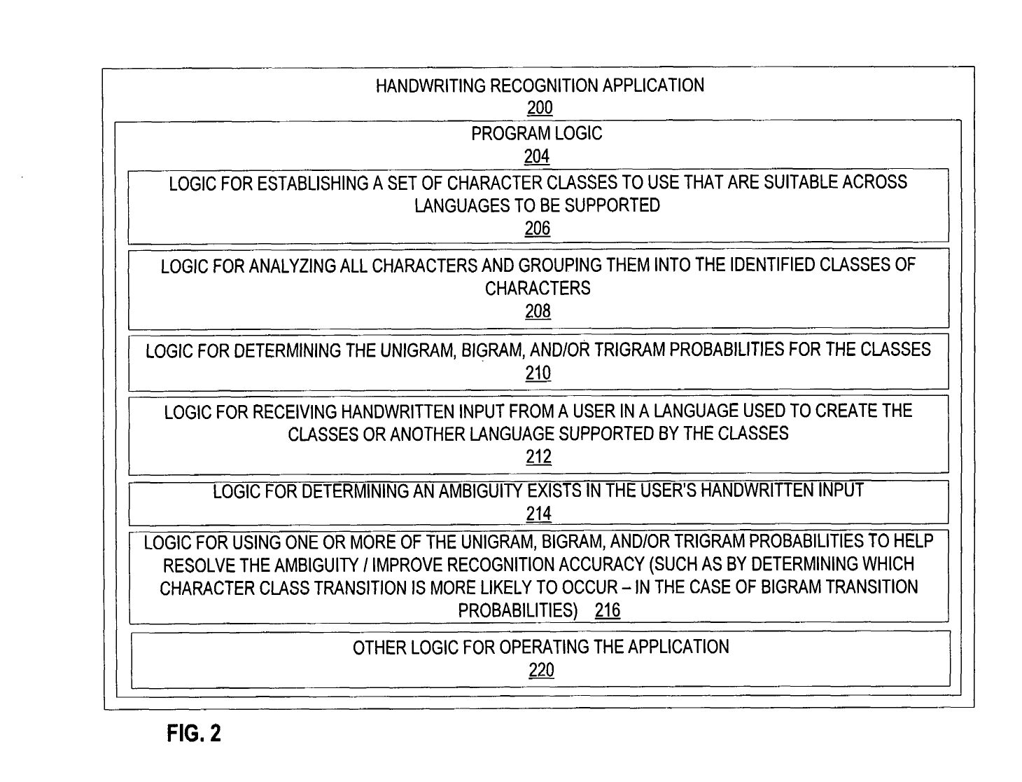

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes handwriting recognition application 200. Handwriting recognition application 200 will be described in further detail in FIG. 2.

Turning now to FIG. 2 with continued reference to FIG. 1, a handwriting recognition application 200 operating on computing device 100 is illustrated. Handwriting recognition application 200 is one of the application programs that reside on computing device 100. However, it will be understood that handwriting recognition application 200 can alternatively or additionally be embodied as computer-executable instructions on one or more computers and/or in different variations than shown on FIG. 1. Alternatively or additionally, one or more parts of handwriting recognition application 200 can be part of system memory 104, on other computers and/or applications 115, or other such variations as would occur to one in the computer software art.

Handwriting recognition application 200 includes program logic 204, which is responsible for carrying out some or all of the techniques described herein. Program logic 204 includes logic for establishing a set of character classes to use that are suitable across languages to be supported 206; logic for analyzing all characters and grouping them into the identified classes of characters 208; logic for determining the unigram, bigram, and/or trigram probabilities for the classes 210; logic for receiving handwritten input from a user in a language used to create the classes or another language supported by the classes 212; logic for determining an ambiguity exists in the user's handwritten input 214; logic for using one or more of the unigram, bigram, and/or trigram probabilities to help resolve the ambiguity/improve recognition accuracy, such as by determining which character class transition is more likely to occur (in the case of bigram transition probabilities) 216; and other logic for operating the application 220. In one implementation, program logic 204 is operable to be called programmatically from another program, such as using a single call to a procedure in program logic 204.

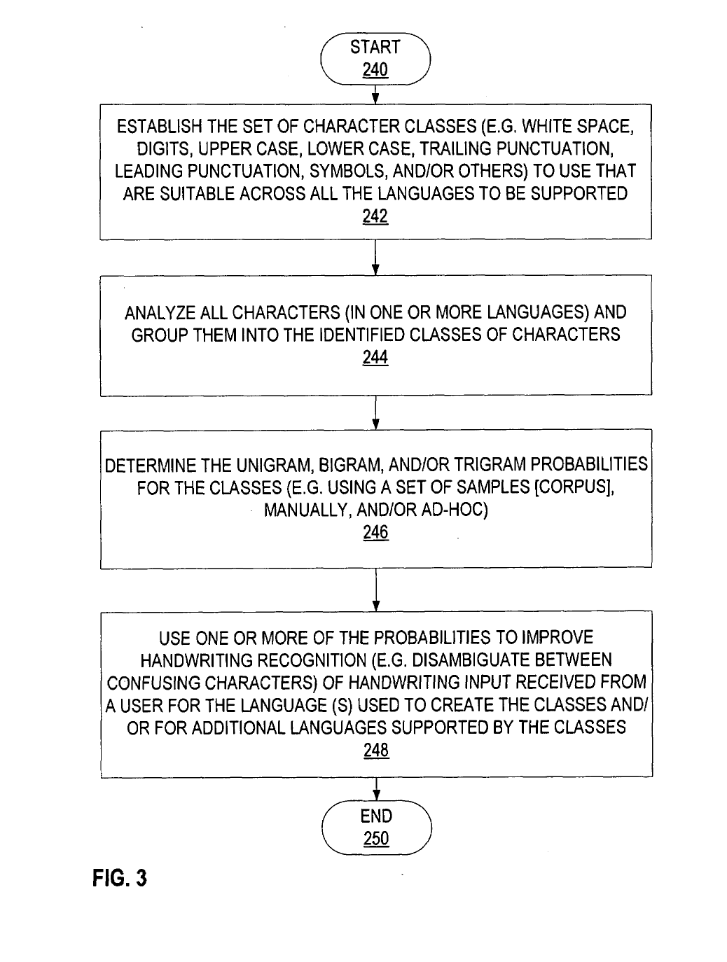

Turning now to FIGS. 3-6 with continued reference to FIGS. 1-2, the stages for implementing one or more implementations of handwriting recognition application 200 are described in further detail. FIG. 3 is a high level process flow diagram for handwriting recognition application 200. In one form, the process of FIG. 3 is at least partially implemented in the operating logic of computing device 100. The procedure begins at start point 240 with establishing the set of character classes (e.g. white space, digits, upper case, lower case, trailing punctuation, leading punctuation, symbols, and/or others) to use that are suitable across all the languages to be supported (stage 242). All characters are analyzed (in one or more of the supported languages) and grouped into the identified classes of characters (stage 244).

The unigram, bigram, and/or trigram probabilities are determined for the classes (e.g. using a set of samples [corpus], manually, and/or ad-hoc) (stage 246). A unigram probability is the probability of the character class by itself. A bigram probability is the probability of transitioning from one character class to the next. A trigram probability is the probability of the three character classes appearing next to each other. One or more of the character class probabilities are then used to improve handwriting recognition (e.g. disambiguate between confusing characters) of handwriting input received from a user for the language(s) used to create the classes and/or for additional languages supported by the classes (stage 248). In one implementation, bigram probabilities are exclusively used to improve recognition. In other implementations, combinations of unigram probabilities, bigram probabilities, and/or trigram probabilities are used to improve recognition. The process ends at end point 250.

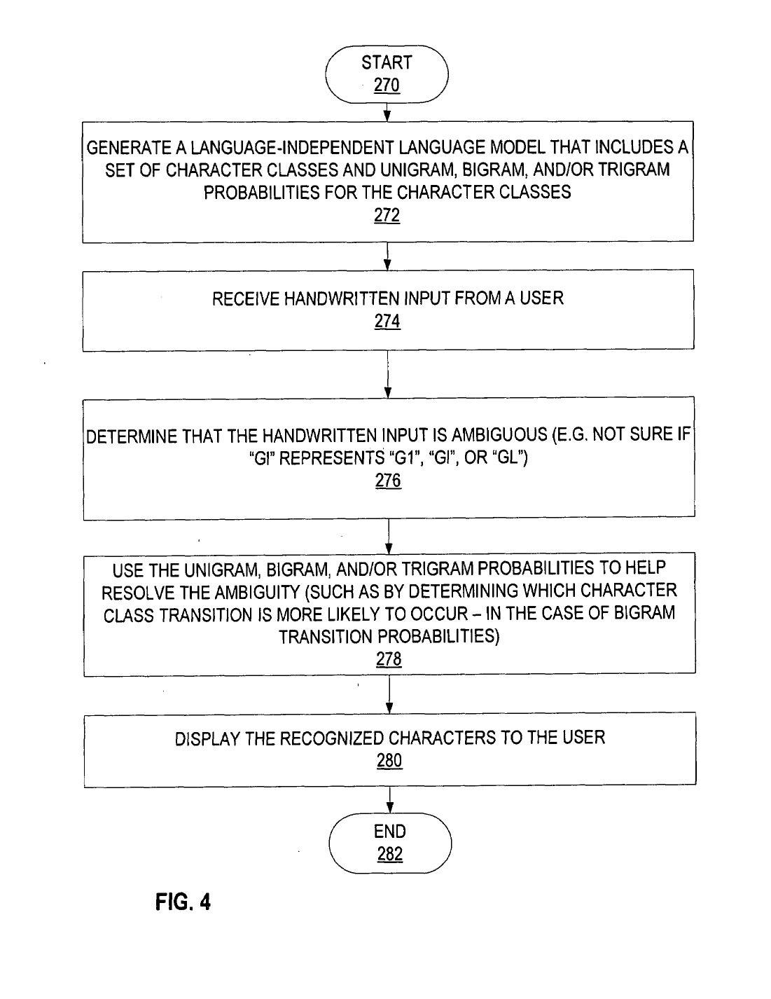

FIG. 4 illustrates one implementation of the stages involved in resolving ambiguous handwritten input using character classes. In one form, the process of FIG. 4 is at least partially implemented in the operating logic of computing device 100. The procedure begins at start point 270 with generating a language-independent language model that includes a set of character classes and unigram, bigram, and/or trigram probabilities for the character classes (stage 272). Handwritten input is received from a user (stage 274). The system determines that the handwritten input is ambiguous (stage 276). As a non-limiting example of an ambiguity is whether the handwritten input “g1” represents “gI” (capital i), “g1” (the number 1), or “gl” (lower case L) (stage 276). The system uses the unigram, bigram, and/or trigram probabilities to help resolve the ambiguity, such as by determining which character class transition is more likely to occur in the case of bigram transition probabilities (stage 278). In the “gl” example previously illustrated, transitions from a lower case character to a digit or to an upper-case character are very unlikely. Furthermore, transitions from a lower-case character to a lower-case character are very likely. Thus, using the bigram transition probabilities, the recognizer would choose the lower-case “l” as its answer. After the ambiguity is resolved, the recognized characters are displayed to the user (stage 280). The process ends at end point 282.

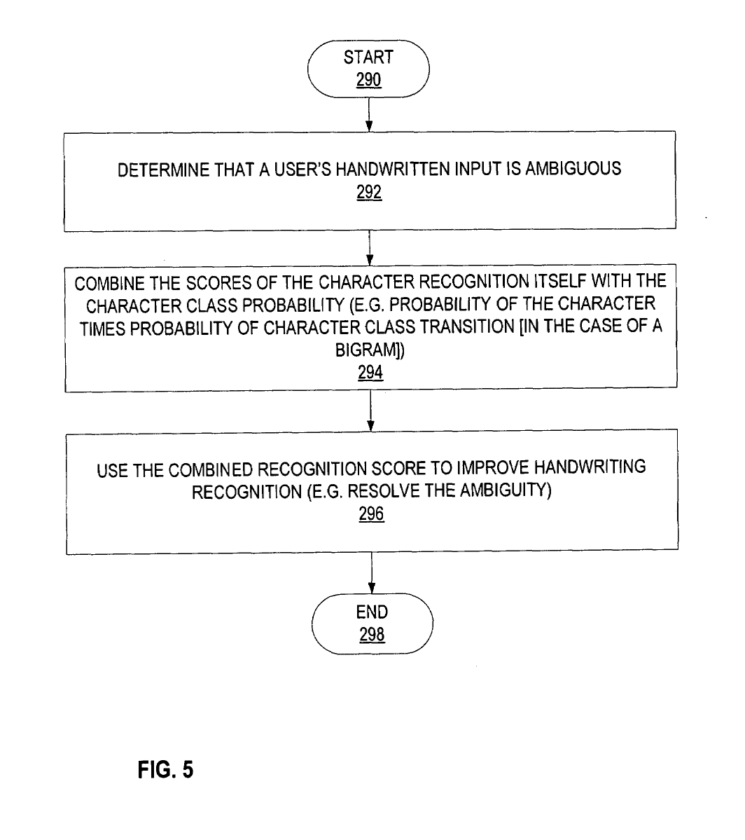

FIG. 5 illustrates one implementation of the stages involved in using character class probabilities to improve recognition. In one form, the process of FIG. 5 is at least partially implemented in the operating logic of computing device 100. The procedure begins at start point 290 with determining that a user's handwritten input is ambiguous (stage 292). The scores of the character recognition itself are combined with the character class probability (e.g. probability of the character multiplied by the probability of the character class transition [in the case of a bigram]) (stage 294). The combined recognition score is used to improve handwriting recognition (e.g. resolve the ambiguity) (stage 296). The process ends at end point 298.

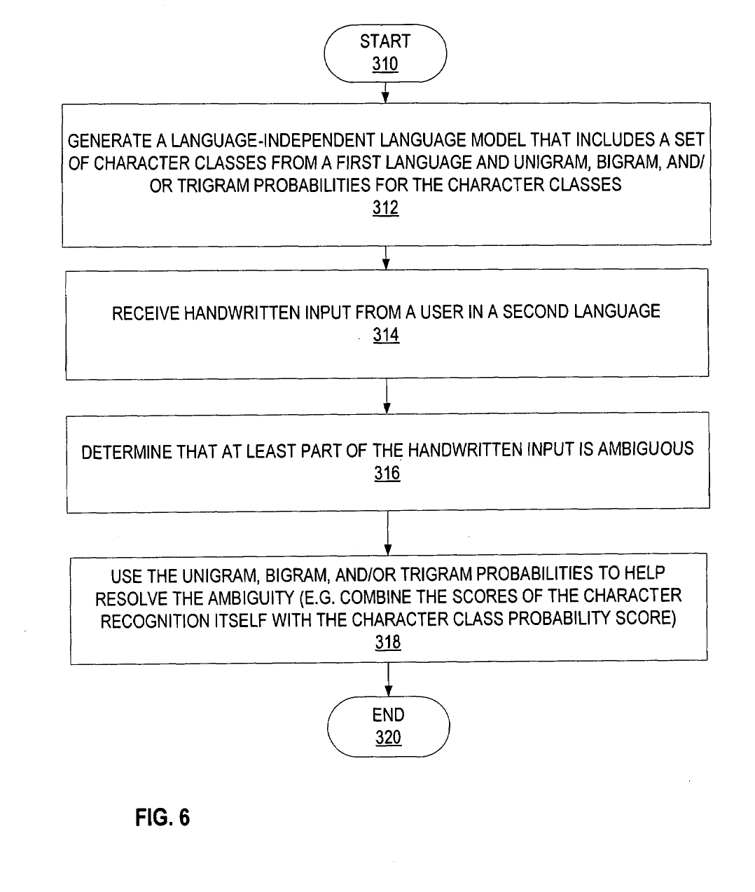

FIG. 6 illustrates one implementation of the stages involved in using character classes from a first language to improve handwriting accuracy for a second language. In one form, the process of FIG. 6 is at least partially implemented in the operating logic of computing device 100. The procedure begins at start point 310 with generating a language-independent language model that includes a set of character classes from a first language and unigram, bigram, and/or trigram probabilities for the character classes (stage 312). The system receives handwritten input from a user in a second language (stage 314). The system determines that at least part of the handwritten input is ambiguous (stage 316). The unigram, bigram, and/or trigram probabilities are used to help resolve the ambiguity, such as to combine the scores of the character recognition itself with the character class probability score (stage 318). The process ends at end point 320.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, and/or data layouts as described in the examples discussed herein could be organized differently on one or more computers to include fewer or additional options or features than as portrayed in the examples.

What is claimed is:

1. A method for improving handwriting recognition comprising the steps of:
establishing a plurality of character classes to use that are suitable across a plurality of languages to be supported;
analyzing a plurality of characters in at least one of the plurality of languages to be supported and grouping the plurality of characters into the character classes;
determining probabilities for the character classes; and
using at least a portion of the character class probabilities to improve a handwriting recognition operation from handwritten input received from a user.

2. The method of claim 1, wherein the probabilities are bigram probabilities.

3. The method of claim 1, wherein the probabilities are unigram probabilities.

4. The method of claim 1, wherein the probabilities are trigram probabilities.

5. The method of claim 1, wherein the using step includes calculating a new recognition score by multiplying a score of a character recognition by a character class probability score determined using the at least a portion of the character class probabilities, and wherein the new recognition score is used to improve the handwriting recognition operation.

6. The method of claim 5, wherein the handwriting recognition operation is improved by using the new score to resolve an ambiguity.

7. The method of claim 1, wherein the character classes are selected from the group consisting of white space, digits, upper case, lower case, trailing punctuation, leading punctuation, and symbols.

8. The method of claim 1, wherein the character class probabilities are bigram class transition probabilities, and wherein the bigram class transition probabilities are used to improve the handwriting recognition operation by determining which character class transition is more likely to occur.

9. The method of claim 1, wherein the character class probabilities are generated according to a process selected from the group consisting of using a set of samples, using a manual operation, and using an ad-hoc operation.

10. A computer-readable medium having computer-executable instructions for causing a computer to perform the steps recited in claim 1.

11. A computer-readable medium having computer-executable instructions for causing a computer to perform steps comprising:
establish a plurality of character classes to use that are suitable across a plurality of languages to be supported;
analyze a plurality of characters in at least one of the languages to be supported and group the characters into the character classes;
determine a plurality of character class probabilities;
determine that an ambiguity exists in a handwritten input received from a user; and
use at least a portion of the character class probabilities to resolve the ambiguity.

12. The computer-readable medium of claim 11, wherein the character class probabilities are selected from the group consisting of bigram probabilities, unigram probabilities, and trigram probabilities.

13. The computer-readable medium of claim 11, wherein the character class probabilities are bigram class transition probabilities, and wherein the bigram class transition probabilities are used to resolve the ambiguity by determining which character class transition is more likely to occur.

14. A method for improving handwriting recognition using a language-independent language model comprising the steps of:
generating a language-independent language model that includes a plurality of character classes and a plurality of character class probabilities;
receiving handwritten input from a user;
determining that the handwritten input is ambiguous;
using at least a portion of the character class probabilities to help resolve the ambiguity; and
displaying the recognized characters.

15. The method of claim 14, wherein the character class probabilities are generated using a first language, and wherein the handwritten input from the user is in a second language.

16. The method of claim 14, wherein the character class probabilities include bigram probabilities.

17. The method of claim 14, wherein the character class probabilities include trigram probabilities.

18. The method of claim 14, wherein the character class probabilities include unigram probabilities.

19. The method of claim 14, wherein the character classes are suitable across a plurality of languages to be supported by the language model.

20. A computer-readable medium having computer-executable instructions for causing a computer to perform the steps recited in claim 14.
